(19) United States
(12) Patent Application Publication
(10) Pub. No.: US 2019/0223500 A1
(43) Pub. Date: Jul. 25, 2019

(54) BATTERY ASSEMBLY AND ELECTRONIC CIGARETTE HAVING SAME

(71) Applicant: SHENZHEN IVPS TECHNOLOGY CO., LTD., Shenzhen (CN)

(72) Inventor: Junwei OUYANG, Shenzhen (CN)

(73) Assignee: SHENZHEN IVPS TECHNOLOGY CO., LTD., Shenzhen (CN)

(21) Appl. No.: 16/147,772

(22) Filed: Sep. 30, 2018

(30) Foreign Application Priority Data
Jan. 19, 2018 (CN) 201820100455.4

(51) Int. Cl. A24F 47/00; H01M 2/10

(52) U.S. Cl. CPC A24F 47/008; H01M 2220/30; H01M 2/1055

(57) ABSTRACT

The invention discloses a battery assembly and an electronic cigarette using the battery assembly, wherein the battery assembly comprises a main body and a cover, the main body is provided with a battery compartment with an opening, one end of the cover toward the main body is provided with an electrode contact member, one end of the cover is rotatably mounted on the main body, and the other end is provided with a engaging part, the main body is provided with a locking groove for receiving the engaging part, the cover is coupled to the main body via snap-fit connection and covers the opening when the engaging part is received in the locking groove, the electrode contact member abuts against the battery in the battery compartment to form an electrical circuit.

### TECHNICAL FIELD

The invention relates to a battery assembly and an electronic cigarette using the battery assembly.

### BACKGROUND

Electronic cigarettes, also known as electronic cigarettes, are mainly used to quit smoking and replace conventional cigarettes. It has an appearance and taste similar to conventional cigarettes, and even has more tastes than conventional cigarettes. It can generate smoke, a taste and a feel like conventional cigarettes. Without tar, suspension particles and other harmful components in conventional cigarettes, electronic cigarettes have gradually replaced conventional cigarettes on the market. The existing electronic cigarettes supply power to the heat generating unit in the atomizer through the battery assembly, so that the heat generating unit heats the tobacco liquid to generate smoke under the driving of the battery assembly, thereby enabling the user to obtain a smoking experience.

However, since the existing electronic cigarette has many functions and a large power, it is necessary to disassemble the battery frequently for charging. The battery cover of the conventional battery assembly is often of a pulling type or fastening and separating type. The design has the defect that it is easy to wear the battery and have a battery short circuit. At the same time, the battery cover is easily lost, which is inconvenient for the user. Therefore, the battery cover of the existing electronic cigarette product is usually mounted on the main body in a manner of rotating and fastening. However, there is also a phenomenon that there is a clearance when the battery cover is in rotating connection with the main body so that it is easy for the user to cause a shake during use, resulting in unstable current contact and abnormal noise.

### SUMMARY

The main object of the invention is to provide a battery assembly, which aims to prevent the phenomenon that the shake of the battery cover during use results in unstable current contact and abnormal noise.

In order to achieve the above object, the invention provides a battery assembly, comprising a main body and a cover, wherein the main body is provided with a battery compartment with an opening, one surface of the cover facing the main body is provided with an electrode contact member, one end of the cover is rotatably mounted on the main body, and the other end is provided with an engaging part, the main body is provided with a locking groove for receiving the engaging part, when the engaging part is received in the locking groove the cover is coupled to the main body via snap-fit connection and covers the opening, the electrode contact member abuts against the battery in the battery compartment to form an electrical circuit, the main body is further provided with at least one elastic member facing the cover, and the elastic member elastically abuts against the cover when the cover is coupled to the main body via snap-fit connection.

Preferably, the main body is provided with a receiving groove matching with the cover, one end of the cover far away from the engaging part is provided with a rotating part, the rotating part is provided with a rotatable shaft assembly and a first shaft hole for receiving the rotatable shaft assembly, two side groove walls of the receiving groove are provided with second shaft holes matching with the rotatable shaft assembly, and the rotatable shaft assembly passes through the first shaft hole and is partially received in the two second shaft holes.

Preferably, the first shaft hole is an oblong hole extending in the direction of a line connecting the rotating part and the engaging part, a locked and fixed state is formed when the cover slides along the oblong hole until the engaging part is received in the locking groove, and an activity disengaged state is formed when the cover slides along the oblong hole until the engaging part is disengaged from the locking groove.

Preferably, the rotatable shaft assembly comprises an elastic connecting member, a sleeve received in the first shaft hole, and two limiting heads exposed at both ends of the sleeve, the elastic connecting member is received in the sleeve and is fixedly connected with the two limiting heads, and each of the limiting heads is partially slidably mounted in the sleeve and abuts against the sleeve when sliding to the end position of the sleeve.

Preferably, the receiving groove comprises a narrow-diameter section, a middle-diameter section and a wide-diameter section, the rotating part is received in the narrow-diameter section, an inner wall of the connecting position between the middle-diameter section and the wide-diameter section is recessed toward the middle-diameter section to form a locking groove, the engaging part comprises two stoppers provided at one end of the cover far away from the rotating part, the two stoppers are provided at both sides of the cover and are each convexly provided with a buckle, and the buckle is buckled to the locking groove to form a locked and fixed state when the stopper slides along the large-diameter section until being in contact with the end of the middle-diameter section.

Preferably, the main body is further provided with a receiving hole for receiving the elastic member, one end of the elastic member is received in the receiving hole and is fixedly connected with the main body, and the other end elastically abuts against the cover when the cover is coupled to the main body via snap-fit connection.

Preferably, the elastic member is an elastic thimble, a spring or an elastic plastic.

Preferably, the elastic member is provided on the small-diameter section and is provided directly facing the rotating part, the rotating part abuts against the elastic member when the cover is mounted on the main body, and the rotating part is provided with an avoidance groove corresponding to the elastic member.

Preferably, the cover is further provided with a positioning hole, and the elastic member is received in the positioning hole when the cover is coupled to the main body via snap-fit connection.

The invention further provides an electronic cigarette comprising an atomizer and a battery assembly, wherein the battery assembly comprises a main body and a cover, the main body is provided with a battery compartment with an opening, one end of the cover toward the main body is provided with an electrode contact member, one end of the cover is rotatably mounted on the main body, and the other end is provided with a engaging part, the main body is provided with a locking groove for receiving the engaging part, the cover is coupled to the main body via snap-fit connection and covers the opening when the engaging part is received in the locking groove, the electrode contact member abuts against the battery in the battery compartment to form an electrical circuit, the main body is further provided with at least one elastic member toward the cover, and the elastic member elastically abuts against the cover when the cover is coupled to the main body via snap-fit connection.

For the battery assembly of the technical solution of the invention, one end of the cover is rotatably mounted on the main body. During the process of assembling and disassembling the battery, when the cover is opened and closed, there is no abrasion between the electrode contact member provided on the cover and the electrode of the battery so as to cause a short circuit, and the cover will not be separated from the main body and is lost, which improves the safety and convenience. Moreover, in the technical solution of the invention, the main body is further provided with at least one elastic member toward the cover. When being mounted on the main body, the cover squeezes the elastic member, so that the elastic member has a certain elastic force on the cover, so that the cover is less likely to shake relative to the main body, further preventing the phenomenon that there is no abrasion between the electrode contact member provided on the cover and the electrode of the battery so as to cause a short circuit, and preventing the phenomenon that the shake of the battery cover during use results in unstable current contact and abnormal noise.

### BRIEF DESCRIPTION OF THE DRAWINGS

For a better illustration of the embodiments of the invention or the technical solution in the prior art, accompanying drawings needed in the description of the embodiments or the prior art are simply illustrated below. Obviously, the accompanying drawings described below are some embodiments of the invention. For those skilled in the art, other accompanying drawings may be obtained according to the structure shown in these accompanying drawings without creative work.

FIG. 1 is a schematic exploded diagram illustrating a connecting structure of a battery assembly according to the invention.

FIG. 2 is a schematic perspective diagram illustrating a mounting structure of a rotatable shaft assembly according to the invention.

FIG. 3 is a partial enlarged schematic diagram at A in FIG. 2 according to the invention.

FIG. 4 is a partial cross-sectional schematic diagram illustrating the locked and fixed state of the battery assembly according to the invention.

FIG. 5 is a schematic diagram illustrating the activity disengaged state of the battery assembly according to the invention.

FIG. 6 is a schematic perspective diagram illustrating a connecting structure of a cover according to the invention.

FIG. 7 is a schematic exploded diagram illustrating a connecting structure of a cover according to the invention.

### DESCRIPTION OF THE REFERENCE NUMBERS

| Reference | | Reference | |
|---|---|---|---|
| number | Name of part | number | Name of part |
| 100 | battery assembly | 36 | electrode mounting |
| | | | plate |
| 10 | main body | 32 | engaging part |
| 11 | battery compartment | 321 | stopper |
| 12 | locking groove | 3211 | buckle |
| 13 | receiving groove | 33 | rotating part |
| 131 | second shaft hole | 331 | rotatable shaft |
| | | | assembly |
| 132 | narrow-diameter section | 3312 | sleeve |
| 133 | middle-diameter section | 3313 | limiting head |
| 134 | wide-diameter section | 332 | first shaft hole |
| 14 | receiving hole | 333 | avoidance groove |
| 30 | cover | 34 | positioning hole |
| 31 | electrode contact member | 35 | handle |
| 311 | mounting hole | 50 | elastic member |

The implementation of aims, the function features and the advantages of the present disclosure are described below in further detail in conjunction with embodiments with reference to the drawings.

### DESCRIPTION OF THE EMBODIMENTS

A clear and complete description as below is provided for the technical solution in the embodiments of the invention in conjunction with the drawings in the embodiments of the invention. Obviously, the embodiments described hereinafter are simply part embodiments of the invention, rather than all the embodiments. All other embodiments obtained by those skilled in the art based on the embodiments in the invention without creative work are intended to be comprised in the scope of protection of the invention.

It should be noted that all directional indications (such as top, bottom, left, right, front, behind . . . ) in the embodiments of the invention are merely to illustrate a relative position relation, a relative motion condition, etc. between each part in a certain state (for example, the state shown in the drawings). If the state changes, the directional indication changes accordingly.

In addition, if terms “first”, “second”, etc. appear in the invention, they are merely for the purpose of description, but cannot be understood as the indication or implication of relative importance or as the implicit indication of the number of the designated technical features; therefore, features defined by “first” and “second” may specifically or implicitly comprise at least one such feature. In addition, technical solutions of each embodiment of the invention may be combined mutually; however, this must be carried out on the basis that those skilled in the art can implement the combination. When the combination of technical solutions has a conflict or cannot be implemented, it should be considered that such combination of technical solutions does not exist and is not in the scope of protection claimed by the invention.

In the invention, unless otherwise specifically stated and defined, terms “connected”, “fixed”, etc. should be interpreted expansively. For example, “fixed” may be fixed connection, detachable connection, or integration; may be mechanical connection or electrical connection; direct connection, indirect connection through an intermediate, or internal communication between two elements or interaction of two elements, unless otherwise specifically defined. Those skilled in the art can understand the specific implication of the above terms in the invention according to specific conditions.

The invention provides a battery assembly 100, which is applied to an electronic cigarette. The electronic cigarette comprises an atomizer (not shown). An oil storing chamber and a heat generating assembly are provided in the atomizer. The battery assembly 100 is provided with an atomizer joint which is fixedly electrically connected with the atomizer, and the main control board provided in the battery assembly 100 controls the output current of the power supply to supply power to the heat generating assembly in the atomizer, so that the heat generating assembly heats tobacco tar when driven by the battery assembly 100 to generate smoke, thus giving the user a smoking experience.

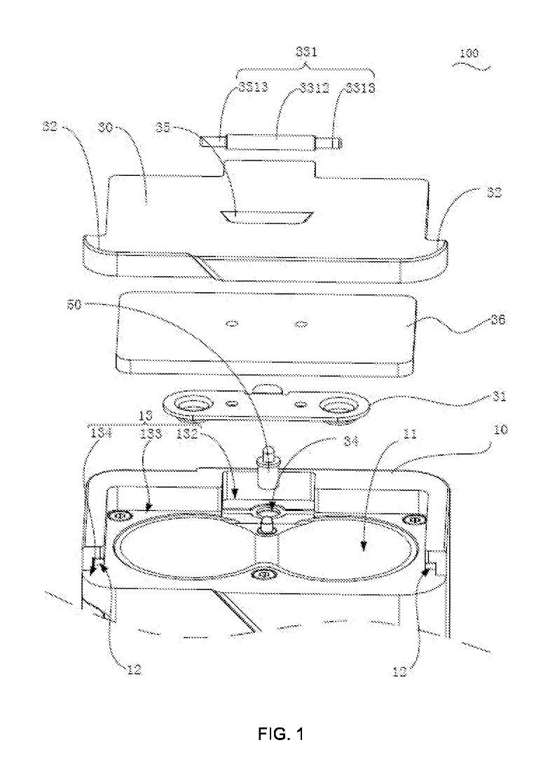

Referring to FIG. 1 to FIG. 7, in the embodiment of the invention, the battery assembly 100 comprises a main body 10 and a cover 30, the main body 10 is provided with a battery compartment 11 with an opening, one surface of the cover 30 facing the main body 10 is provided with an electrode contact member 31, one end of the cover 30 is rotatably mounted on the main body 10, and the other end is provided with a engaging part 32, the main body 10 is provided with a locking groove 12 for receiving the engaging part 32, the cover 30 is coupled to the main body 10 via snap-fit connection and covers the opening when the engaging part 32 is received in the locking groove 12, the electrode contact member 31 abuts against the battery in the battery compartment 11 to form an electrical circuit (i.e., an electrical loop), the main body 10 is further provided with at least one elastic member 50 toward the cover 30, and the elastic member 50 elastically abuts against the cover 30 when the cover 30 is coupled to the main body 10 via snap-fit connection.

For the battery assembly 100 of the technical solution of the invention, one end of the cover 30 is rotatably mounted on the main body 10. During the process of assembling and disassembling the battery, when the cover 30 is opened and closed, there is no abrasion between the electrode contact member 31 provided on the cover 30 and the electrode of the battery so as to cause a short circuit, and the cover 30 will not be separated from the main body 10 and is lost, which improves the safety and convenience. Moreover, in the technical solution of the invention, the main body 10 is further provided with at least one elastic member 50 toward the cover 30. When being mounted on the main body 10, the cover 30 squeezes the elastic member 50, so that the elastic member 50 has a certain elastic force on the cover 30, so that the cover 30 is less likely to shake relative to the main body 10, further preventing the phenomenon that there is no abrasion between the electrode contact member 31 provided on the cover 30 and the electrode of the battery so as to cause a short circuit, and preventing the phenomenon that the shake of the battery cover during use results in unstable current contact and abnormal noise.

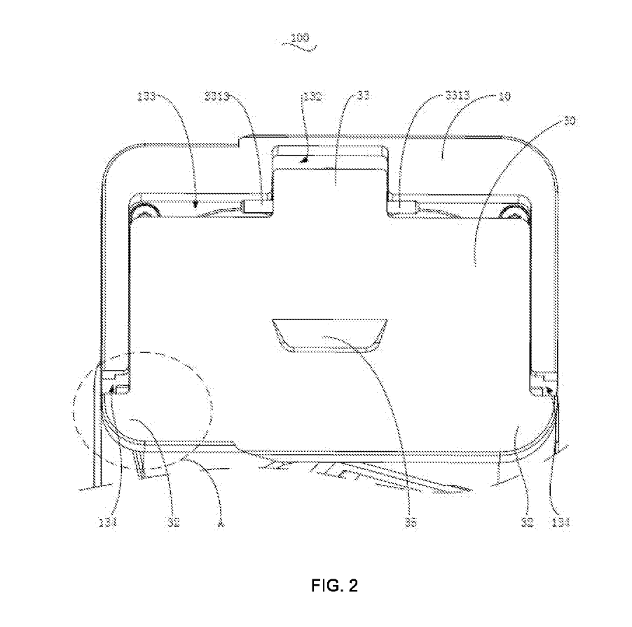

Specifically, as shown in FIG. 1 or FIG. 2, in the embodiment of the invention, the main body 10 is provided with a receiving groove 13 matching with the cover 30, one end of the cover 30 far away from the engaging part 32 is provided with a rotating part 33, the rotating part 33 is provided with a rotatable shaft assembly 331 and a first shaft hole 332 for receiving the rotatable shaft assembly 331, two side groove walls of the receiving groove 13 are provided with second shaft holes 131 matching with the rotatable shaft assembly 331, and the rotatable shaft assembly 331 passes through the first shaft hole 332 and is partially received in the two second shaft holes 131. Here, specifically, the rotating part 33 is convexly provided at one end of the cover 30 far away from the engaging part. A first shaft hole 332 is provided on the rotating part 33, and two second shaft holes 131 are provided correspondingly at two side groove walls of the receiving groove 13 so that the cover 30 may be received in the two second shaft holes 131 after the rotatable shaft assembly 331 passes through the first shaft hole 332. Thereby, the cover 30 is rotatably mounted on the main body 10. With respect to the conventional connecting manner in which one end of the cover 30 is provided with a rotating part 33, an outer periphery of the main body 10 is convexly provided with a mounting part corresponding to the rotating part 33, and then a rotatable shaft passes through the rotating part 33 and the mounting part so that the cover 30 and the main body 10 are hinged, both ends of the rotatable shaft assembly 331 of the embodiment are received in the main body 10 to prevent the phenomenon that the rotatable shaft assembly 331 falls off due to shaking during use.

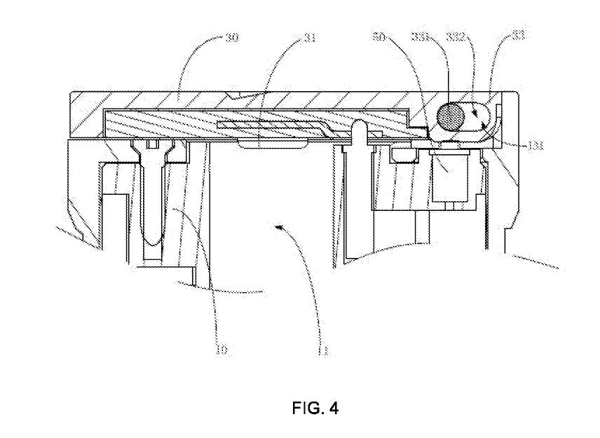

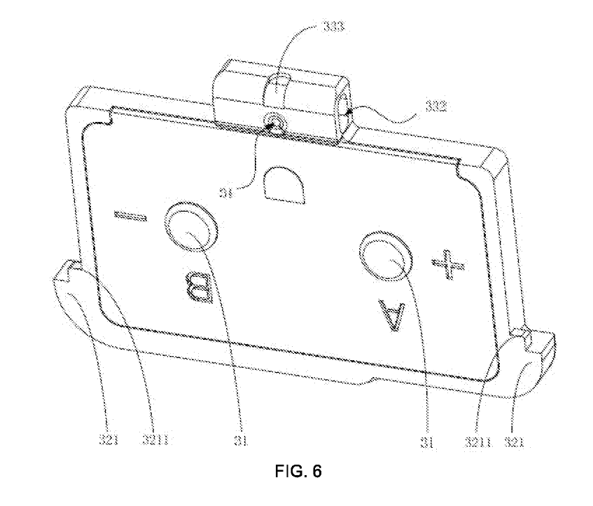

Specifically, as shown in FIG. 4 or FIG. 6, in the embodiment of the invention, the first shaft hole 332 is an oblong hole extending in the direction of a line connecting the rotating part 33 and the engaging part 32, a locked and fixed state is formed when the cover 30 slides along the oblong hole until the engaging part 32 is received in the locking groove 12, and an activity disengaged state is formed when the cover 30 slides along the oblong hole until the engaging part 32 is disengaged from the locking groove 12. Here, in the embodiment, the first shaft hole 332 is an oblong hole. The cover 30 is not only rotatable around the rotatable shaft assembly 331, but also performs linear push-and-pull movement in the direction of a line connecting the rotating part 33 and the engaging part 32. When the user pushes the cover 30 to move toward the rotating part 33, the engaging part 32 is driven to slide into the locking groove 12 to form a locked and fixed state. At this time, the elastic member 50 elastically abuts against the cover 30 so that the engaging part 32 abuts against and is locked to the inner groove wall of the locking groove 12; when the user pushes the cover 30 to move toward the engaging part 32, the engaging part 32 slides out of the locking groove 12 to form the activity disengaged state. At this time, a gap is generated between the cover 30 and the main body 10 under the elastic restoring force of the elastic member 50, so that a clearance is formed between the electrode contact member 31 and the electrode end of the battery to prevent short circuit due to the abrasion while facilitating opening and closing the cover 30.

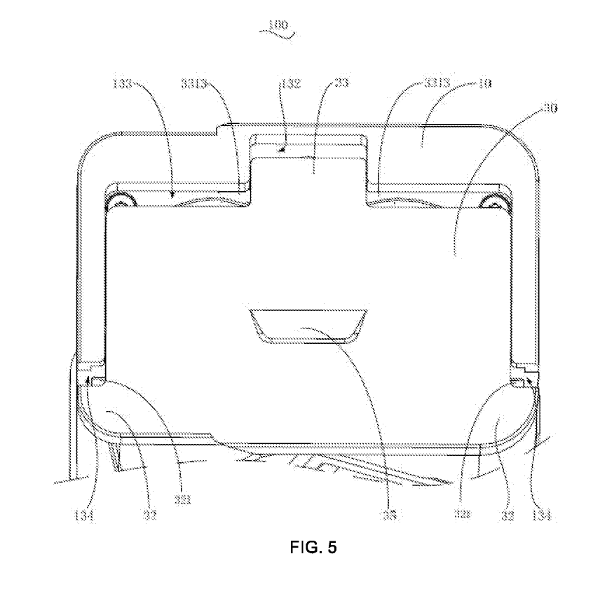

It is to be understood that, in the actual application process, as shown in FIG. 1, FIG. 2 or FIG. 5, in order to facilitate the user to push the rear cover, in another embodiment of the invention, the manner in which one end of the cover 30 far away from the main body 10 is further provided with a non-slip rib or a groove handle 35 also falls within the scope of protection of the invention.

Specifically, as shown in FIG. 1, in the embodiment of the invention, the rotatable shaft assembly 331 comprises an elastic connecting member, a sleeve 3312 received in the first shaft hole 332, and two limiting heads 3313 exposed at both ends of the sleeve 3312, the elastic connecting member is received in the sleeve 3312 and is fixedly connected with the two limiting heads 3313, and each of the limiting heads 3313 is partially slidably mounted in the sleeve 3312 and abuts against the sleeve 3312 when sliding to the end position of the sleeve 3312. Here, in the embodiment, the elastic connecting member adopts a spring. The spring is received in the sleeve 3312, and both ends of the spring are connected with the limiting heads 3313, so that the limiting heads 3313 can squeeze the spring under the external driving force and slide toward the inside of the sleeve 3312; when the external driving force disappears, the limiting head 3313 is ejected under the elastic restoring force of the spring, which is convenient for assembly and disassembly.

Specifically, as shown in FIG. 1 to FIG. 3, in the embodiment of the invention, the receiving groove comprises a narrow-diameter section 132, a middle-diameter section 133 and a wide-diameter section 134, the rotating part 33 is received in the narrow-diameter section 132, an inner wall of the connecting position between the middle-diameter section 133 and the wide-diameter section 134 is recessed toward the middle-diameter section 133 to form a locking groove 12, the engaging part 32 comprises two stoppers 321 provided at one end of the cover 30 far away from the rotating part 33, the two stoppers 321 are provided at both sides of the cover 30 and are each convexly provided with a buckle 3211, and the buckle 3211 is buckled to the locking groove 12 to form a locked and fixed state when the stopper 321 slides along the large-diameter section until being in contact with the end of the middle-diameter section 133. Here, in the embodiment, the rotating part 33 is received in the narrow-diameter section 132, and the two second shaft holes 131 are provided on the two side groove walls of the narrow-diameter section 132, so that when the rotatable shaft assembly 331 is mounted on the main body 10, the limiting heads 3313 is completely received in the second shaft hole 131, thereby effectively preventing the phenomenon that the emission of rotatable shaft assembly 331 falls off due to the shake. At the same time, the connection between the middle-diameter section 133 and the wide-diameter section 134 is recessed toward the middle-diameter section 133 to form a locking groove 12. The engaging part 32 is provided with two stoppers 321 on both sides at one end of the cover 30 far away from the rotating part 33. Each of the stoppers 321 is convexly provided with a buckle 3211, the buckle 3211 slides into the locking groove 12, and the elastic member 50 elastically abuts against the cover 30 so that the buckle 3211 closely fits the inner groove wall of the locking groove 12, thereby improving the stability of the connection and preventing the phenomenon that the shake results in abnormal noise.

Further, as shown in FIG. 1, the main body 10 is further provided with a receiving hole 14 for receiving the elastic member 50, one end of the elastic member 50 is received in the receiving hole 14 and is fixedly connected with the main body 10, and the other end elastically abuts against the cover 30 when the cover 30 is coupled to the main body 10 via snap-fit connection. Here, in the embodiment, the main body 10 is provided with a receiving hole 14 for receiving the elastic member 50, so that after the long-term use of the user, the elastic member 50 will not shift to result in the phenomenon that the elastic member 50 has deflection loss in the direction of restoring force.

It is to be understood that, in the actual application process, the manner in which the elastic member 50 is received in the receiving hole 14 for limiting and fixing is not limited. For example, the manner in which the main body 10 is provided with a fixed column of the elastic member 50 (not shown) to fix the elastic member 50 falls within the scope of protection of the invention.

Specifically, the elastic member 50 is an elastic thimble, a spring, or an elastic plastic. Here, in the embodiment, an elastic thimble (not labeled) is used. The elastic thimble comprises a tube socket (not labeled) having an opening at one end, a spring (not shown), and a hemispherical contact (not labeled). The tube socket is connected with the receiving hole 14 in an interference fit. The spring is received in the tube socket. One end of the hemispherical contact is slidably mounted in the tube socket and the other end is exposed from the tube socket, and the hemispherical contact elastically abuts against the cover 30 when the cover 30 is coupled to the main body 10 via snap-fit connection.

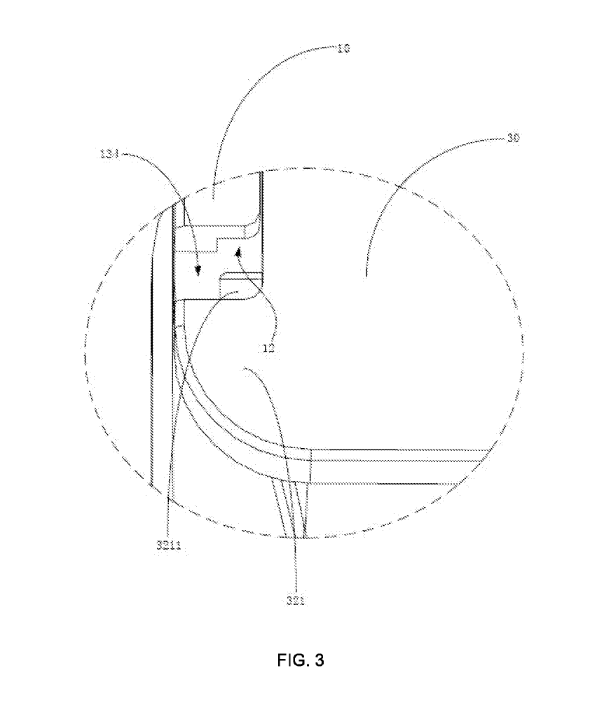

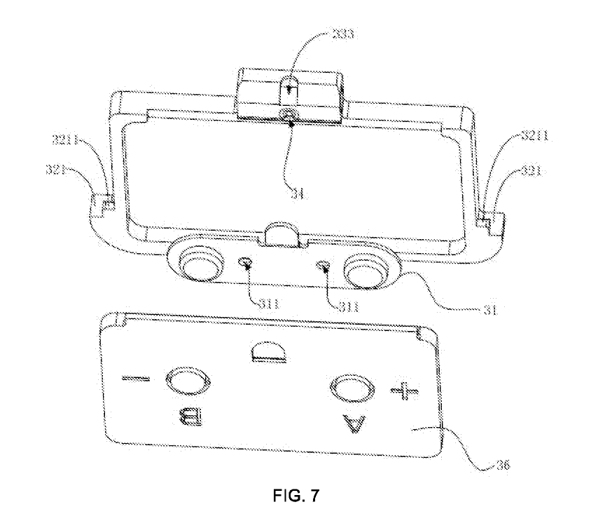

Specifically, as shown in FIG. 1, FIG. 3, FIG. 6 and FIG. 7, in the embodiment of the invention, the elastic member 50 is provided on the small-diameter section and is provided directly facing the rotating part 33, the rotating part 33 abuts against the elastic member 50 when the cover 30 is mounted on the main body 10, and the rotating part 33 is provided with an avoidance groove 333 corresponding to the elastic member 50. Here, the elastic member 50 is provided on the small-diameter section, so that the elastic member 50 always abuts against the rotating part 33, which may effectively prevent the phenomenon that the cover 30 shakes in the first shaft hole 332 under no external force. At the same time, the user has a certain resistance feeling when operating, improving the using experience of the user. At the same time, the rotating part 33 is provided with an avoidance groove 333 corresponding to the elastic member 50. The groove depth value of the avoidance groove 333 is gradually reduced along the trajectory in which the cover 30 and the elastic member 50 perform contact movement when the cover 30 is opened until the cover 30 is fastened.

Further, as shown in FIG. 6 or FIG. 7, in the embodiment of the invention, the cover 30 is further provided with a positioning hole 34, and the elastic member 50 is received in the positioning hole 34 when the cover 30 is coupled to the main body 10 via snap-fit connection. Here, in the embodiment, the outer periphery of the positioning hole 34 is provided in a gradually expanding and rounded manner. The positioning hole 34 is provided at one end of the avoidance groove 333 close to the engaging part 32. When the cover 30 slides into the locked and fixed state along the first shaft hole 332, the elastic member 50 slides into the positioning hole 34 and makes a silvery noise, which is convenient for the user to judge whether it is in the locked and fixed state.

Specifically, as shown in FIG. 6 or FIG. 7, in the embodiment of the invention, at least two batteries may be received in the battery compartment 11 of the battery assembly 100. The cover 30 comprises an electrode mounting plate 36. The cover 30 is provided with a groove for receiving the electrode mounting plate 36. The electrode contact member 31 comprises a conductive sheet (not labeled) and at least two contact heads (not labeled). The conductive sheet is received in the groove. One end of each of the contact heads is connected with the conductive sheet, and the other end is provided through the electrode mounting plate 36 corresponding to an electrode of the battery (not labeled). When the cover 30 is coupled to the main body 10 via snap-fit connection, a contact head is in contact with an electrode of the battery to form an electrical circuit through the conductive sheet.

Specifically, as shown in FIG. 6 or FIG. 7, in the embodiment, the electrode contact member 31 is correspondingly provided with at least two mounting holes 311, which is convenient for machine-shaping by mounting or injection molding the electrode contact member 31 to the cover 30.

The invention further provides an electronic cigarette, wherein the electronic cigarette comprises an atomizer and a battery assembly 100. Refer to the above embodiment for the specific structure of the battery assembly 100. Due to the use of all the technical solutions of all the above embodiments, the electronic cigarette has at least all the beneficial effects brought by the technical solutions of the above embodiments, which will not be described in detail herein.

The above are preferred embodiments of the invention merely and are not intended to limit the patent scope of the invention. Any equivalent structures made according to the description and the accompanying drawings of the invention without departing from the idea of the invention, or any equivalent structures applied in other relevant technical fields directly or indirectly are intended to be comprised in the patent protection scope of the invention.

What is claimed is:

1. A battery assembly, comprising a main body and a cover, wherein the main body is provided with a battery compartment with an opening, one surface of the cover facing the main body is provided with an electrode contact member, one end of the cover is rotatably mounted on the main body, and the other end is provided with an engaging part, the main body is provided with a locking groove for receiving the engaging part, when the engaging part is received in the locking groove, the cover is coupled to the main body via snap-fit connection and covers the opening, the electrode contact member abuts against the battery in the battery compartment to form an electrical circuit, the main body is further provided with at least one elastic member facing the cover, and the elastic member elastically abuts against the cover when the cover is coupled to the main body via snap-fit connection.

2. The battery assembly according to claim 1, wherein the main body is provided with a receiving groove matching with the cover, one end of the cover far away from the engaging part is provided with a rotating part, the rotating part is provided with a rotatable shaft assembly and a first shaft hole for receiving the rotatable shaft assembly, two side groove walls of the receiving groove are provided with second shaft holes matching with the rotatable shaft assembly, and the rotatable shaft assembly passes through the first shaft hole and is partially received in the two second shaft holes.

3. The battery assembly according to claim 2, wherein the first shaft hole is an oblong hole extending in the direction of a line connecting the rotating part and the engaging part, a locked and fixed state is formed when the cover slides along the oblong hole until the engaging part is received in the locking groove, and an activity disengaged state is formed when the cover slides along the oblong hole until the engaging part is disengaged from the locking groove.

4. The battery assembly according to claim 2, wherein the rotatable shaft assembly comprises an elastic connecting member, a sleeve received in the first shaft hole, and two limiting heads exposed from both ends of the sleeve, the elastic connecting member is received in the sleeve and is fixedly connected with the two limiting heads, and each of the limiting heads is partially slidably mounted in the sleeve, when sliding to the ends of the sleeve, each of the limiting heads abuts against the sleeve.

5. The battery assembly according to claim 2, wherein the receiving groove comprises a narrow-diameter section, a middle-diameter section and a wide-diameter section, the rotating part is received in the narrow-diameter section, an inner wall of a connecting position between the middle-diameter section and the wide-diameter section is recessed toward the middle-diameter section to form a locking groove, the engaging part comprises two stoppers provided at one end of the cover far away from the rotating part, the two stoppers are provided at both sides of the cover and are each convexly provided with a buckle, and the buckle is buckled to the locking groove to form a locked and fixed state when the stopper slides along the large-diameter section until being in contact with the end of the middle-diameter section.

6. The battery assembly according to claim 5, wherein the main body is further provided with a receiving hole for receiving the elastic member, one end of the elastic member is received in the receiving hole and is fixedly connected with the main body, and the other end elastically abuts against the cover when the cover is coupled to the main body via snap-fit connection.

7. The battery assembly according to claim 6, wherein the elastic member is an elastic thimble, a spring or an elastic plastic.

8. The battery assembly according to claim 6, wherein the elastic member is provided on the small-diameter section and is provided directly facing the rotating part, the rotating part abuts against the elastic member when the cover is mounted on the main body, and the rotating part is provided with an avoidance groove corresponding to the elastic member.

9. The battery assembly according to claim 6, wherein the cover is further provided with a positioning hole and the elastic member is received in the positioning hole when the cover is coupled to the main body via snap-fit connection.

10. An electronic cigarette comprising an atomizer, wherein the electronic cigarette further comprises the battery assembly according to claim 1.
